(19) United States
(12) Patent Application Publication
(10) Pub. No.: US 2023/0078828 A1
(43) Pub. Date: Mar. 16, 2023

(54) INFORMATION PROCESSING SYSTEM, SENSOR SYSTEM, INFORMATION PROCESSING METHOD, AND PROGRAM

(71) Applicant: Panasonic Intellectual Property Management Co., Ltd., Osaka (JP)

(72) Inventors: Yutaka HIROSE, Kyoto (JP); Yusuke YUASA, Kyoto (JP); Shigeru SAITOU, Kyoto (JP); Shinzo KOYAMA, Osaka (JP); Akihiro ODAGAWA, Osaka (JP); Masayuki SAWADA, Osaka (JP)

(21) Appl. No.: 17/913,089

(22) PCT Filed: Mar. 31, 2020
(86) PCT No.: PCT/JP2020/014724

§ 371 Date: Sep. 20, 2022

(51) Int. Cl. G01S 17/89; G01S 17/10; G06T 7/521

(52) U.S. Cl. CPC G01S 17/89; G01S 17/10; G06T 7/521; G06T 2207/10028

(57) ABSTRACT

An information processing system includes an object information generator and an output unit. The object information generator generates object information. A piece of the object information indicates a feature of an object present in a target distance section. The target distance section is one selected from a plurality of distance sections defined by dividing the distance measurable range in accordance with differences in elapsed times from a point of time when a light emitting unit emits a measuring light. The object information generator generates the piece of the object information based on a distance section signal associated with the target distance section. The output unit outputs the object information.

### TECHNICAL FIELD

The present disclosure relates to in processing systems, sensor systems, information processing methods, and programs. The present disclosure relates specifically to an information processing system, a sensor system, an information processing method, and a program for performing processing on information about a distance to an object.

### BACKGROUND ART

Patent Literature 1 discloses a human flow analysis system. The human flow analysis system includes an imaging terminal and an analysis server. The imaging terminal and the analysis server are connected to each other via a network.

The imaging terminal includes a distance image generation remit, a relative position detection unit, an absolute position calculation unit, a person information generation unit, and a transmission unit. The distance image generation unit generates a distance image within a predetermined imaging area. The relative position detection unit detect a relative position of a person present in the imaging area with respect to a position of the imaging terminal. The absolute position calculation unit calculates, an absolute position of the person based on the relative position detected by the relative position detection unit and an absolute position of the imaging terminal. The “absolute position” is defined using a position of a predetermined fixed point. The person information generation unit generates person information including a piece of information about the absolute position of the person calculated by the absolute position calculation unit and a piece of information about a time when the person is present at that absolute position. The transmission unit transmits the person information generated by the person information generation unit to the analysis server via the network.

The analysis server generates a person-based information group that collects person information estimated to be person information on the same person from a plurality of received pieces of person information. The analysis server analyzes a person-based movement information based on the person-based information.

### CITATION LIST

### Patent Literature

Patent Literature 1: JP 2017-224148 A

### SUMMARY OF INVENTION

An information processing system such as the human flow analysis system of Patent Literature 1 may be desired to reduce a processing time taken to generate object information about an object present in a target space. The present disclosure is achieved in view of the above circumstances, and an object thereof is to provide an information processing system, a sensor system, an information processing method, and a program that can contribute to reduce the processing time.

An information processing system of an aspect of the present disclosure is configured to perform processing on information indicated by an electric signal generated by an optical sensor. The optical sensor includes a light receiving unit configured to receive a reflection light that is a measuring light emitted from a light emitting unit toward a target space, reflected from a distance measurable range within the target space. The light receiving unit includes a plurality of pixels. The electric signal indicates information about a pixel that has received the light out of the plurality of pixels. The information processing system includes an object information generator and an output unit. The object information generator is configured to generate object information. A piece of the object information indicates a feature of an object present in a target distance section. The target distance section is one selected from a plurality of distance sections defined by dividing the distance measurable range in accordance with differences in elapsed times from a point of time when the light emitting unit emits the measuring light. The electric signal includes a plurality of distance section signals associated respectively with the plurality of distance sections. The object information generator is configured to generate the piece of the object information based on a distance section signal associated with the target distance section, out of the plurality of distance section signals. The output unit is configured to output the object information.

A sensor system of an aspect of the present disclosure includes the information processing system and the optical sensor.

An information processing method is for performing processing on information indicated by an electric signal generated by an optical sensor. The optical sensor includes a light receiving unit configured to receive a reflection light that is a measuring light emitted from a light emitting unit toward a target space, reflected from a distance measurable range within the target space. The light receiving unit includes a plurality of pixels. The electric signal indicates information about a pixel that has received the reflection light out of the plurality of pixels. The information processing method includes generating object information. A piece of the object information indicates a feature of an object present in a target distance section. The target distance section is one selected from a plurality of distance sections defined by dividing the distance measurable range in accordance with differences in elapsed times from a point of time when the light emitting unit emits the measuring light The electric signal includes a plurality of distance section signals associated respectively with the plurality of distance sections. The step of generating the object information includes generating the piece of the object information based on a distance section signal associated with the target distance section, out of the plurality of distance section signals. The information processing method includes outputting the object information.

A program of an aspect of the present disclosure is a program configured to cause one or more processors to execute the information processing method.

### BRIEF DESCRIPTION OF DRAWINGS

FIG. 1 is an exemplary view illustrating a method for measuring a distance to an object using a sensor system according to an embodiment;

FIG. 2 is a block diagram of the sensor system according to the embodiment;

FIG. 3 is a schematic diagram of a pixel of an optical sensor of the sensor system according to the embodiment;

FIG. 4 is a block diagram of the optical sensor according to the embodiment;

FIG. 5 is a block diagram of an information processing system of the sensor system according to the embodiment;

FIG. 6 is a flowchart illustrating a flow of a processing performed by an object information generator of the information processing system according to the embodiment;

FIG. 7 is a view for illustrating an example of processing performed by the object information generator according to the embodiment;

FIG. 8 is a view for illustrating the example of processing performed by the object information generator according to the embodiment;

FIG. 9 is a view for illustrating the example of processing performed by the object information generator according to the embodiment;

FIG. 10 is a view for illustrating the example of processing performed by the object information generator according to the embodiment;

FIG. 11 is a view for illustrating the example of processing performed by the object information generator according to the embodiment;

FIG. 12 is a view for illustrating the example of processing performed by the object information generator according to the embodiment;

FIG. 13 is a timing chart illustrating timings of the processing performed by the information processing system according to the embodiment; and

FIG. 14 is a block diagram of a part of an information processing system in a sensor system according to a variation.

### DESCRIPTION OF EMBODIMENTS

An information processing system 100, a sensor system 200, an information processing method and a program according to an embodiment will now be described in detail with reference to the accompanying drawings. Note that the embodiment to be described below is only an exemplary one of various embodiments of the present disclosure and should not be construed as limiting. Rather, the embodiment may be readily modified in various manners depending on a design choice or any other factor as long as the advantages of the present disclosure are achievable. The drawings to be referred to in the following description of embodiments are all schematic representations. That is to say, the ratio of the dimensions (including thicknesses) of respective constituent elements illustrated on the drawings does not always reflect their actual dimensional ratio.

### (1) Overview

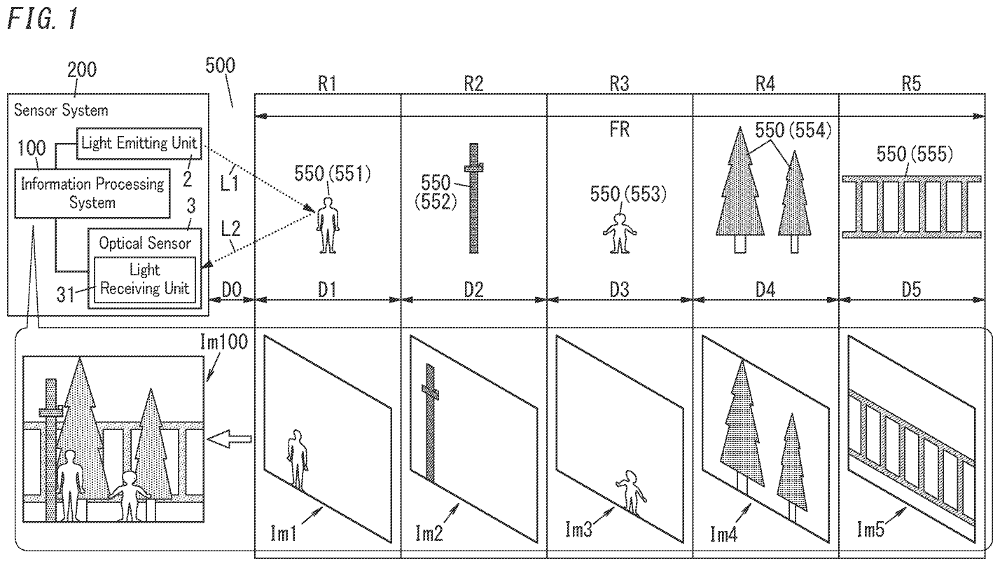

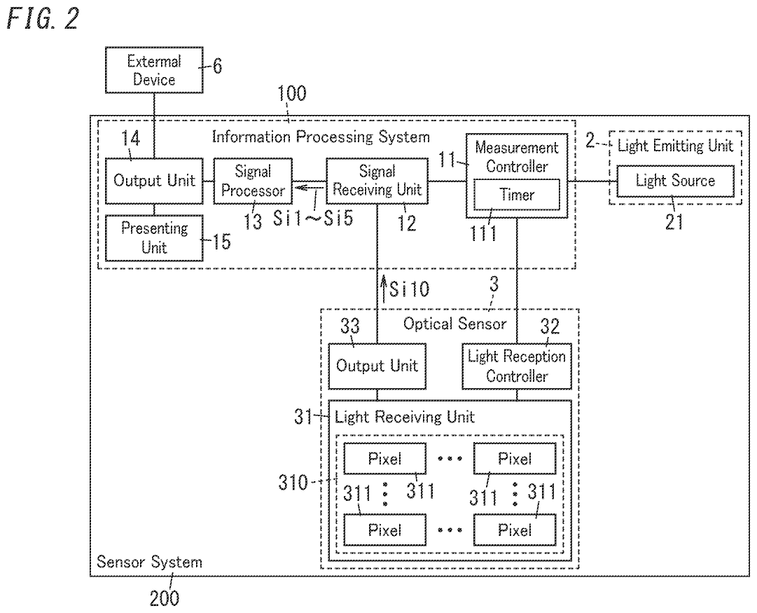

As shown in FIG. 1, the information processing system 100 of the present embodiment is a system for performing processing on information indicated by an electric signal Si10 generated by an optical sensor 3. The optical sensor 3 includes a light receiving unit 31. The light receiving unit 31 is configured to receive a light (reflection light) L2 that is a measuring light Li emitted from a light emitting unit 2 toward a target space 500, reflected from a distance measurable range within the target space 500. In FIG. 1, the measuring light L1 emitted from the light emitting unit 2 and the light L2 which is the measuring light L1 reflected by the object 550 are schematically shown by dotted arrows. As shown in FIG. 2, the light receiving unit 31 includes a plurality of pixels 311. The electric signal Si10 generated by the optical sensor 3 indicates information about a pixel 311 that has received the light L2, out of the plurality of pixels 311.

As shown in FIG. 1, the distance measurable range FR is divided into a plurality of (e.g., five) distance sections R1 to R5 in accordance with differences in elapsed times from a point of time when the light emitting unit 2 emits the measuring light L1. Specifically, a distance from the sensor system 200 to an arbitrary point in the target space 500 uniquely corresponds to a roundtrip time of the light. Therefore, it is possible to divide the distance measurable range FR into the plurality of distance sections R1 to R5 by way of sorting, by regular time intervals, the elapsed time from a point of time when the light emitting unit 2 emits the measuring light L1.

The electric signal Si10 includes a plurality of distance section signals Si1 to Si5 associated respectively with the plurality of distance sections R1 to R5.

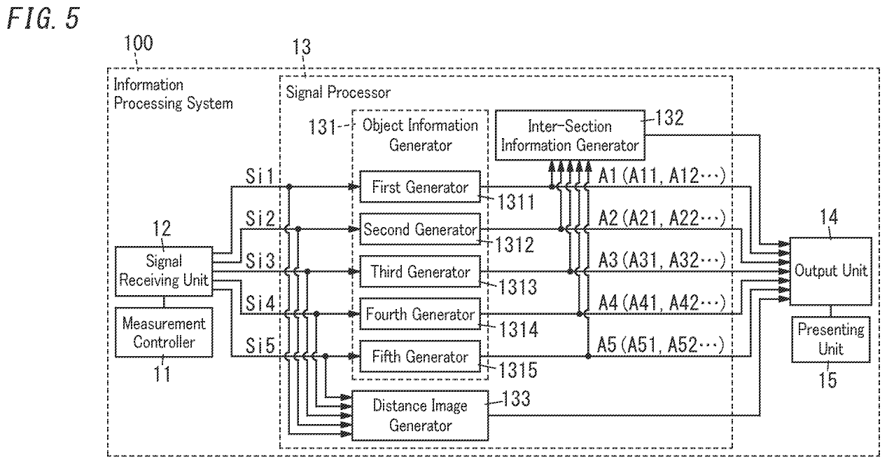

As shown in FIG. 5, the information processing system 100 includes an object information generator 131 and an output unit (information output unit) 14.

The object information generator 131 is configured to generate pieces of object information A1 to A5. Each of the pieces of the object information A1 to A5 is a piece of information indicating a feature of an object 550 present in a target distance section which is one selected from the plurality of distance sections R1 to R5. The object information generator 131 is configured to generate each piece of the object information based on a distance section signal associated with the target distance section, out of the plurality of distance section signals Si1 to Si5. Each of the pieces of the object information A1 to A5 is metadata (i.e., data that provides information about other data, or data that includes properly about and/or information relates to other data).

The output unit 14 is configured to output the pieces of the object information A1 to A5 generated by a signal processor 13. The output unit 14 is configured to output the pieces of the object information A1 to A5 to an external device 6, for example.

According the information processing system 100 of the present embodiment, a piece of the object information about an object 550 present in a target distance section which is one of the plurality of distance sections R1 to R5 is generated based on a distance section signal associated with this target distance section. For example, a piece of the object information A1 about an object 550 present in a distance section R1 is generated based on a distance section signal Si1 generated in association with the distance section R1. This can reduce the data size of data to be processed, compared to a case where information is generated using a distance image (i.e., an image including information about a whole of distance sections within an imaging area) such as the imaging terminal described in Patent Literature 1. Accordingly, the processing time can be reduced.

Furthermore, according to the information processing system 100 of the present embodiment, whenever the optical sensor 3 generates a distance section signal (e.g., distance section signal Si1) associated with a target distance section (e.g., distance section R1), it is possible to generate a piece of object information (piece of object information A1) about the distance section R1 without waiting the generation of distance section signals (such as Si2, Si3, . . . ) associated with other distance sections (such as distance sections R2, R3, . . . ). This enables to generate and output the piece of the object information in semi-real time.

### (2) Details

Hereinafter, the information processing system 100 and the sensor system 200 including the same will be described more in detail with reference to the Drawings.

### (2.1) Outline of Distance Measurement by Sensor System

Described first is an outline of the principle how to the sensor system 200 of the present embodiment measures the distance with reference to FIG. 1.

The sensor system 200 is configured to measure a distance to an object 550 based on the Time Of Flight (TOF) method. As shown in FIG. 1, the sensor system 200 measures a distance to the object 550 using a light (reflection light) L2 that is the measuring light L1 emitted from the light emitting unit 2 and reflected by the object 550. The sensor system 200 may be used for the purpose of an object recognition system installed on a vehicle to detect the presence of an obstacle, a surveillance camera or a security camera to detect an object (or person) or the like, for example.

The sensor system 200 is configured to measure the distance to the object 550 present in the distance measurable range FR within the target space 500. The distance measurable range FR may be a parameter that is determined depending on a length of time (setting time) from when the light emitting unit 2 emits the measuring light L1 until when the optical sensor 3 performs the last exposure operation of the light receiving unit 31. The distance measurable range FR may have a length, although not particularly limited thereto, within a range of several tens of centimeters to several tens of meters, for example. According to the sensor system 200, the distance measurable range FR may be fixed or may be variably set.

Specifically, the sensor system 200 is configured to determine whether any object 550 is present or not with respect to each of the plurality of (e.g., five) distance sections R1 to R5 defined by dividing the distance measurable range FR. The sensor system 200 is further configured to, with respect to each distance section in which any object 550 is determined to be present, generate a piece of object information indicating the feature(s) of the object 550. The plurality of distance sections R1 to R5 are defined by dividing the distance measurable range FR in accordance with differences in elapsed times from a point of time when the light emitting unit 2 emits the measuring light L1. In other words, the distance measurable range FR is constituted by the plurality of distance sections R1 to R5. In the embodiment, the plurality of distance sections R1 to R5 have the same lengths as each other. Although not particularly limited, each of the plurality of distance sections R1 to R5 may have a length within a range of several centimeters to several meters, for example. Alternatively, the plurality of distance sections R1 to R5 may not have the same lengths. Also, the number of the distance sections is not particularly limited. The number of the distance sections may typically be selected from the group of 1 to 15.

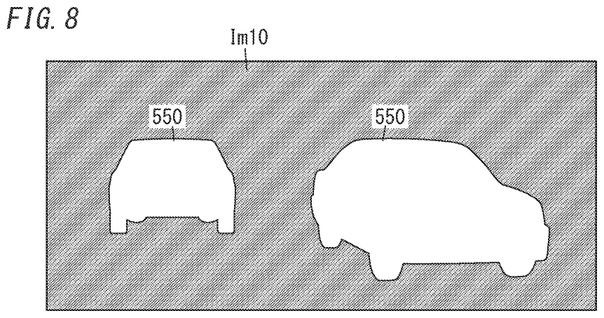

The sensor system 200 may be configured to start the exposure of the pixels 311 of the optical sensor 3 (start the exposure operation) at a point of time when a time corresponding to the twice of a distance to the nearest point of a target distance section (measurement target) elapses from a time when the light emitting unit 2 emits the measuring light L1, for example, where the target distance section is one selected from the plurality of distance sections R1 to R5. The sensor system 200 may further be configured to finish the exposure of the pixels 311 of the optical sensor 3 (finish the exposure operation) at a point of time when a time corresponding to the twice of a distance to the furthest point of this distance section elapses. Operating the optical sensor 3 in this manner while any object 550 is present in the target distance section, the light L2 should be received by a particular pixel(s) 311 of a region corresponding to a two-dimensional position (a position in a plane perpendicular to an optical axis of the sensor system 200) where the object 550 is present, out of the plurality of pixels 311 of the light receiving unit 31 of the optical sensor 3. Accordingly, it is possible to obtain information about: whether or not any object 550 is present in the target distance section; and the two-dimensional position of the object 550. Furthermore, by giving a value “1” or “0” to each of the plurality of pixels 311 according to a result whether any object 550 is present at this pixel (whether the pixel receives the light L2 or not), a binary image (distance section image; see FIG. 8) of the target distance section can be obtained that shows the region (two-dimensional position) where the object 550 is present.

The sensor system 200 of the embodiment is configured to perform a plurality times of light receiving operation with respect to each distance section measurement. Each of the plurality times of light receiving operation includes the emission of the measuring light L1 and the exposure (exposure operation) of the pixels 311 of the optical sensor 3. The sensor system 200 is further configured to, when the number of times that a certain pixel 311 receives the light L2 (the number of light reception) exceeding a threshold, determine that any object 550 (at least part of the object 550) is present at a position corresponding to this pixel 311. Such a plurality times of light receiving operation can contribute to reduce the influence of the noise.

The sensor system 200 performs the above-described operation with respect to each of the plurality of distance sections R1 to R5. As a result, it is possible to determine whether any object 550 is present or absent, to obtain a piece(s) of the object information, and to obtain the distance section image, with respect to each distance section.

It will be described more in detail how the sensor system 200 operates with reference to the example of FIG. 1. In the example of FIG. 1, at least one object 550 is present in each of the plurality of distance sections R1 to R5. Specifically, in the distance section R1, a person 551 is present as the object 550. In the distance section R2, a utility pole 552 is present as the object 550. In the distance section R3, a person 553 is present as the object 550. In the distance section R4, two trees 554 are present as the objects 550. In the distance section R5, a fence 555 is present as the object 550. Hereinafter, for convenience of the explanation, a distance from the sensor system 200 to the nearest point of the distance section R1 will be expressed by “D0”. Moreover, the lengths of the distance sections R1 to R5 will be expressed by “D1” to “D5”, respectively. Therefore, a distance from the sensor system 200 to the furthest point of the distance section R1 is expressed by “D0+D1”. Typically, “D0” may be 0 meter. The whole length of the distance measurable range FR can be expressed by “D0+D1+D2+D3+D4+D5”.

For example, in order to determine whether any object 550 is present in the distance section R1, the sensor system 200 starts the exposure of the optical sensor 3 at a point of time when a time “2×D0/c” elapses, and finishes the exposure of the optical sensor 3 at a point of time when a time “2×(D0+D1)/c” elapses, from a time when the light omitting unit 2 emits the measuring light L1. Here, “c” denotes the speed of light. In the distance section R1, as shown in FIG. 1, the person 551 as the object 550 is present at a position corresponding to pixels 311 of a lower region out of the plurality of pixels 311 of the optical sensor 3. Therefore, as to the pixels 311 of the optical sensor 3 of the region corresponding to the position of the person 551, the number of light reception (the number of times that the pixel 311 receives the light L2) should exceed the threshold. On the other hand, as to the rest of the pixels 311, the number of light receptions should not exceed the threshold. As a result, the distance section image Im1 shown in FIG. 1 is obtained with regard to the distance section R1.

Likewise, in order to determine whether any object 550 is present in the distance section R2, the sensor system 200 starts the exposure of the optical sensor 3 at a point of time when a time “2×(D0+D1)/c” elapses, and finishes the exposure of the optical sensor 3 at a point of time when a time “2×(D0+D1+D2)/c” elapses, from a time when the light emitting unit 2 emits the measuring light L1. In the distance section R2, as shown in FIG. 1, the utility pole 552 as the object 550 is present at a position corresponding to pixels 311 of one side region in the horizontal axis out of the plurality of pixels 311 of the optical sensor 3. Therefore, as the pixels 311 of the optical sensor 3 of the region corresponding to the position of the utility pole 552, the number of light reception (the number of times the pixel 311 receives the light L2) should exceed the threshold. On the other hand, as the rest of the pixels 311, the number of light receptions should not exceed the threshold. As a result, the distance section image Im2 shown in FIG. 1 is obtained with regard to the distance section R2. The distance section images Im3 to Im5 shown in FIG. 1 are also obtained with regard to the respective distance sections R3 to R5 in a similar manner.

It should be noted that a part of the tree 554, which is the object 550 present in the distance section R4, is positioned behind and therefore is concealed by the person 553, which is the object 550 present in the distance section R3. In FIG. 1, however, the tree 554 is shown in the distance section image Im4 as its actual shape, for the easy understanding. The same applies to other distance section images.

The sensor system 200 is further configured to combine the plurality of distance section images Im1 to Im5 obtained with regard to the plurality of distance sections R1 to R5 to generate a distance image Im100 about the distance measurable range FR. Specifically, the sensor system 200 gives different colors (or weights) to the plurality of distance section images Im1 to Im5 of the pixels 311 of the regions corresponding to the objects 550, and add the plurality of distance section images Im1 to Im5 to each other. As a result, the distance image Im100 shown in FIG. 1 is obtained, for example.

The sensor system 200 of the present embodiment can generate the distance section images Im1 to Im5 and the distance image Im100 according to the above-described manner.

Alternatively, the sensor system 200 may be configured to not generate the distance section images Im1 to Im5, but to generate information (signals) from which the distance section images Im1 to Im5 are derivable. The same applies to the distance image Im100.

### (2.2) Configuration of Sensor System

Next, the configuration of the sensor system 200 is described with reference to FIGS. 2 to 4.

As shown in FIG. 2, the sensor system 200 includes the information processing system 100, the light emitting unit 2, and the optical sensor 3. The optical sensor 3 includes the light receiving unit 31, a light reception controller 32, and an output unit 33.

The light emitting unit 2 includes a light source 21 configured to emit the measuring light L1 to the object 550. The measuring light L1 may be a pulsed light. The measuring light L1 used for the TOF method-based distance measurement may be a single wavelength light, have a comparatively short pulse width, and have a comparatively high peak intensity. The measuring light L1 may have a wavelength within the near-infrared wavelength band if the sensor system 200 (the optical sensor 3) is intended to be used in a town area, since the light haying such a wavelength is a low relative luminosity for the human eyes and also is less likely to be affected by the ambient light such as the sun-light. In the present embodiment, the light source 21 may include a laser diode and emit a pulsed-laser light, for example. The light source 21 that emits the pulsed laser meets the requirement of Class 1 laser product or Class 2 laser product specified by the standard for Safety of laser products (JIS C 6802). However, the light source 21 is not limited to the above-described configuration, but may include a Light Emitting Diode (LED), a Vertical Cavity Surface Emitting LASER (VCSEL), a halogen lamp, or the like. Moreover, the measuring light L1 may have a wavelength within a wavelength band other than the near-infrared band.

The light receiving unit 31 includes a pixel unit 310. The pixel unit 310 includes the plurality of pixels 311.

In the pixel unit 310, the plurality of pixels 311 are arranged in a two-dimensional array, specifically in a matrix pattern, as shown in FIG. 2. The pixel unit 310 constitutes an image sensor. Each pixel 311 is configured to receive light during an exposure duration only. The optical sensor 3 is configured to output, to the information processing system 100, an electric signal generated by the pixel unit 310.

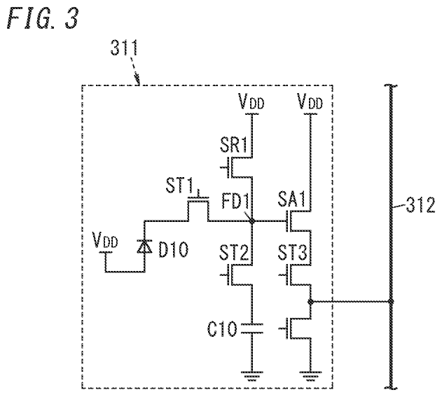

FIG. 3 shows the circuit diagram of each pixel 311 of the pixel unit 310. As shown in FIG. 3, the pixel 311 includes a photoelectric conversion element D10, a charge accumulation element C10, a floating diffusion portion FD1, an amplification transistor SA1, transferring transistors ST1, ST2, ST3, and a reset transistor SR1.

When receiving the light L2 that is the measuring light L1 emitted from the light emitting unit 2 and reflected by the object 550 while an internal power V_{DD} (bias voltage) is applied to the photoelectric conversion element D10, the photoelectric conversion element D10 generates an electric charge. The photoelectric conversion element D10 generates the electric charge of the saturation charging amount in response to a single photon. That is, the photoelectric conversion element D10 generates a fixed amount (i.e., saturation charging amount) of electric charge in response to the reception of the single photon. In the present embodiment, the photoelectric conversion element D10 includes an avalanche photodiode (APD).

The charge accumulation element C10 accumulates thereon at least part of the electric charge generated by the photoelectric conversion element D10. The charge accumulation element C10 includes a capacitor. The charge accumulation element C10 has a capacitance that can store such the amount of electric charge that the photoelectric conversion element D10 generates a plurality of times. Therefore, the charge accumulation element C10 can total the electric charges generated by the photoelectric conversion element D10, which contributes to improve the S/N ratio of the electric signal of the pixel unit 310 and to improve the measurement accuracy. In the present embodiment, a first end of the charge accumulation element C10 is connected to the ground.

The floating diffusion portion FD1 is located between the photoelectric conversion element D10 and the charge accumulation element C10. On the floating diffusion portion FD1, the electric charge can be accumulated.

The amplification transistor SA1 has a gate electrode connected to the floating diffusion portion FD1. Accordingly, a drain-source resistance of the transistor SA1 changes depending on the amount of the electric charge that is accumulated on the floating diffusion portion FD1. The transistor SA1 has a source electrode connected to the internal power V_{DD}. The transistor SA1 outputs, to an output line 312, an electric signal (pixel signal) having a value corresponding to the amount of electric charge generated by the photoelectric conversion element D10 (equivalent to a value corresponding to the amount of electric charge accumulated on the charge accumulation element C10).

The transistor ST1 is connected between a cathode of the photoelectric conversion element D10 and the floating diffusion portion FD1. The transistor ST2 is connected between the floating diffusion portion FD1 and a second end of the charge accumulation element C10. The transistor ST3 is connected between the output line 312 and a drain electrode of the transistor SA1. A node between the transistor ST3 and the output line 312 is connected to the ground via a transistor which serves as a constant current load of a source follower that includes the transistor SA1. The transistor SR1 is connected between the floating diffusion portion FD1 and the internal power V_{DD}.

Each pixel 311 is configured to be exposed for a predetermined exposure duration (performs the exposure operation) to generate the electric charge of which amount reflects a result whether the pixel 311 receives the photon or not during the exposure duration.

Specifically, in the exposure operation of the pixel 311, the transistors ST1, SR1 are firstly turned on, and thereby the respective electric charges accumulated on the photoelectric conversion element D10 and the floating diffusion portion FD1 are reset. Then, the transistors ST1, SR1 are turned off to start the exposure (exposure operation) of the pixel 311. If the photoelectric conversion element D10 receives a photon during the exposure duration, then the photoelectric conversion element D10 generates the electric charge (of the saturation charging amount). When the transistor ST1 is turned on to finish the exposure duration, the electric charge generated by the photoelectric conversion element D10 is transferred to the floating diffusion portion FD1. The electric charge transferred to the floating diffusion portion FD1 is, when the transistor ST1 is turned off and then the transistor ST2 is turned on, further transferred to the charge accumulation element C10 and accumulated thereon. After the electric charge is transferred to the charge accumulation element C10, the transistor SR1 is turned on to reset the electric charge accumulated on the floating diffusion portion FD1. After the reset of the electric charge accumulated on the floating diffusion portion FD1 the transistor SR1 is turned off again.

In short, according to the exposure operation of the pixel 311, if the photoelectric conversion element D10 receives no photon during the exposure duration, then no electric charge is accumulated on the charge accumulation element C10. Meanwhile, if the photoelectric conversion element D10 receives any photon during the exposure duration, then the electric charge of the saturation charging amount is accumulated on the charge accumulation element C10.

As described in the above section “(2.1) Outline of Distance Measurement by Sensor System”, the sensor system 200 is configured to perform a plurality times of light receiving operation with respect to each distance section, where each of the plurality times of light receiving operation includes the emission of the measuring light L1 and the exposure operation of the pixels 311 of the optical sensor 3. Thus, after the plurality times of light receiving operation, the charge accumulation element C10 of each pixel 311 accumulates thereon the electric charge of which amount corresponds to the number of times that the photoelectric conversion element D10 receives the photon (i.e., light L2) among the plurality times of light receiving operation. The number of times that the light receiving operation is performed (light receiving times) is not particularly limited, but may be 20 times, for example.

After the plurality times (light receiving times) of light receiving operation, the transistor ST2 is turned on, and thereby the electric charge accumulated on the charge accumulation element C10 is transferred to the floating diffusion portion FD1. As a result, the gate electrode of the transistor SA1 is applied thereto a voltage, the voltage value of which reflects the amount of electric charge accumulated on the floating diffusion portion FD1 (i.e., reflects the number of photons that the photoelectric conversion element D10 has received). Next, the transistor ST3 is turned on, and thereby a signal is output to the output line 312, of which value reflects the number of photons that the photoelectric conversion element D10 has received (i.e., reflects the amount of electric charge accumulated on the charge accumulation element C10). Thereafter, the transistors SR1, ST1, ST2 are turned on, and thereby the unnecessary electric charges remaining on the photoelectric conversion element D10, the floating diffusion portion FD1 and the charge accumulation element C10 are discharged.

In short, the optical sensor 3 is configured to determine whether each of the plurality of pixels 311 receives the light L2 or not, based on results of one or more times of, more specifically a plurality times of, light receiving operation. Each light receiving operation includes the emission of the measuring light L1 from the light emitting unit 2 and the exposure operation of the pixel 311.

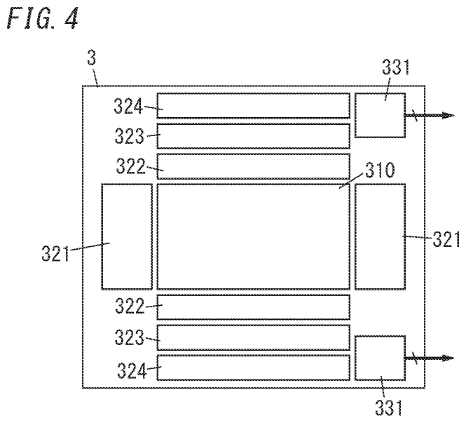

As shown in FIG. 4, the light reception controller 32 includes a vertical driver circuit 321, a column circuit 322, a column analog-to-digital conversion (ADC) circuit 323, and a shift register circuit 324. The output unit 33 includes an output interface 331.

The vertical driver circuit 321 is configured to supply each pixel 311 with a control signal (first control signal) via a control line to read out the signal from the pixel 311. There are a plurality of the control lines. The first control signal may include a plurality of control signals to turn on the transistors ST1, ST2, ST3, SR1 of the pixel 311, respectively. The plurality of pixels 311 are arranged in the matrix pattern, and a control line is provided with respect to each row of the matrix pattern, for example. Therefore, two or more pixels 311 arranged in the same row simultaneously receive the control signal.

The signal, read out from the pixel 311, is supplied to the column circuit 322 via the output line 312 (see FIG. 3). An output line 312 is provided with respect to each column of the matrix pattern of the plurality of pixels 311.

The column circuit 322 performs signal processing on the signal read from the pixel 311, such as amplification processing, addition processing, and the like. The column circuit 322 may include a column amplification circuit to perform the amplification processing, a noise reduction circuit to reduce the noise component contained in the signal such as a correlative double sampling (CDS) circuit, or the like, for example.

The column AD conversion circuit 323 is configured to perform the AD conversion on the signal (analog signal) processed by the column circuit 322, and holds the signal thus converted (i.e., digital signal).

The shift register circuit 324 is configured to supply a control signal (second control signal) to the column AD conversion circuit 323 to cause the column AD conversion circuit 323 to sequentially transfer the signals, which have been AD converted and held thereon, to the output unit 33 on a column-basis.

The output interface 331 of the output unit 33 includes a Low Voltage Differential Signal (LVDC) circuit, for example. The signals generated by the light receiving unit 31 (i.e., by the pixels 311) are output through the output unit 33 to the outside (to the information processing system 100, in the embodiment). The signals of the pixel unit 310 (plurality of pixels 311) output through the output unit 33 correspond to the distance section signals Si1 to Si5 which are electric signals associated respectively with the distance sections R1 to R5. The distance section signals Si1 to Si5 may have a form of a binary signal where “1 (high-level)” indicates that “the number of light reception” of a pixel 311 exceeds the threshold (this pixel 311 corresponds to a region where any object 550 is present) and “0 (low-level)” indicates that “the number of light reception” of a pixel 311 does not exceed the threshold (this pixel 311 corresponds to a region where no object 550 is present).

### (2.3) Information Processing System

As shown in FIG. 2, the information processing system 100 includes a measurement controller 11, a signal receiving unit 12, the signal processor 13, the output unit 14 and a presenting unit 15. The measurement controller 11 and the signal processor 13 may be implemented as a computer system including one or more processors (microprocessors) and one or more memories. The computer system performs the function of the measurement controller 11 and the signal processor 13 by the one or more processors executing one or more programs (applications) stored in the one or more memories. In this embodiment, the program is stored in advance in the memory. Alternatively, the program may be downloaded via a telecommunications line such as the Internet or distributed after having been stored in a storage medium such as a memory card.

The measurement controller 11 is configured to control the light emitting unit 2 and the optical sensor 3.

The measurement controller 11 controls the operations of the light emitting unit 2, such as the timing when the light source 21 emits the measuring light L1 (i.e., timing of the light emission), the pulse width of the measuring light L1 emitted from the light source 21, and the like.

The measurement controller 11 controls the operation timings of the transistors ST1 to ST3, SR1 through the light reception controller 32 to control the operations of the optical sensor 3, such as the timing when the pixel 311 (the photoelectric conversion element D10) is exposed (exposure timing), the exposure duration, the read-out timing of the electric signal, and the like, with regard to each pixel 311. The exposure tinting corresponds to a point of time when the transistors ST1, SR1 of the pixel 311 are switched from on to off, for example. The timing of finishing the exposure duration corresponds to a point of time when the transistor ST1 of the pixel 311 is switched from off to on. The read-out timing corresponds to a point of time when the transistor ST3 of the pixel 311 is switched from off to on.

The measurement controller 11 may include a timer 111, and control the timing of the light emission of the light emitting unit 2 and various operation timings of the optical sensor 3 based on the time measured by the timer 111, for example.

The measurement controller 11 is configured to sequentially perform the distance measurements with regard to the plurality of distance sections R1 to R5 that constitute the distance measurable range FR. Specifically, the measurement controller 11 first, by performing the light emission from the light emitting unit 2 and the exposure of the optical sensor 3, generates the distance section signal Si1 associated with the distance section R1 which is the distance section nearest to the sensor system 200. Next, the measurement controller 11 generates, by performing the light emission from the light emitting unit 2 and the exposure of the optical sensor 3, the distance section signal Si2 associated with the distance section R2 which is the distance section second nearest to the sensor system 200. The measurement controller 11 also generates the distance section signals Si3 to Si5 associated respectively with the distance sections R3 to R5 one after another. The measurement controller 11 performs the set of the distance measurements for the distance sections R1 to R5 (i.e., generation of the distance section signals Si1 to Si5) many times repeatedly.

The signal receiving unit 12 is configured to receive the electric signal Si10 output from the output unit 33 of the optical sensor 3. The electric signal Si10 includes either one of the distance section signals Si1 to Si5. The electric signal Si10 received by the signal receiving unit 12 is processed by the signal processor 13.

As shown in FIG. 5, the signal processor 13 includes the object information generator 131, an inter-zone information generator 132, and a distance image generator 133.

The object information generator 131 is configured to generate the piece of the object information indicating the feature(s) of the object present in a corresponding one of the plurality of distance sections R1 to R5, based on a distance section signal associated with a target distance section, out of the electric signals generated by the optical sensor 3, with respect to the plurality of distance sections R1 to R5.

The object information generator 131 includes generators (first generator 1311 to fifth generator 1315) the number of which corresponds to the number of the distance sections (i.e., five). The first generator 1311 receives a distance section signal Si1 from the signal receiving unit 12. The first generator 1311 generates a piece of the object information A1 about the object 550 present in the distance section R1 (person 551 in the example of FIG. 1), based on the distance section signal Si1 which is an electric signal associated with the distance section R1. Likewise, the second generator 1312 generates a piece of the object information A2 about the object 550 present in the distance section R2 (utility pole 552 in the example of FIG. 1), based on the distance section signal Si2 which is an electric signal associated with the distance section R2. The third generator 1313 generates a piece of the object information A3 about the object 550 present in the distance section R3 (person 553 in the example of FIG. 1), based on the distance section signal Si3 which is an electric signal associated with the distance section R3. The fourth generator 1314 generates a piece of the object information A4 about the object 550 present in the distance section R4 (trees 554 in the example of FIG. 1), based on the distance section signal Si4 which is an electric signal associated with the distance section R4. The fifth generator 1315 generates a piece of the object information A5 about the object 550 present in the distance section R5 (fence 555 in the example of FIG. 1), based on the distance section signal Si5 which is an electric signal associated with the distance section R5.

According to the above explanation and FIG. 5, the plurality of distance section signals Si1 to Si5 are transmitted to the object information generator 131 (of the signal processor 13) through mutually different paths, and are processed by mutually different elements (specifically. the first generator 1311 to the fifth generator 1315) of the object information generator 131. However, this is mere the explanation purpose, and the present disclosure is not limited thereto. Alternatively, the plurality of distance section signals Si1 to Si5 may be transmitted to the object information generator 131 through the same path, and may be processed by the same element.

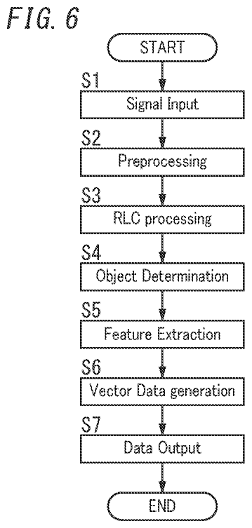

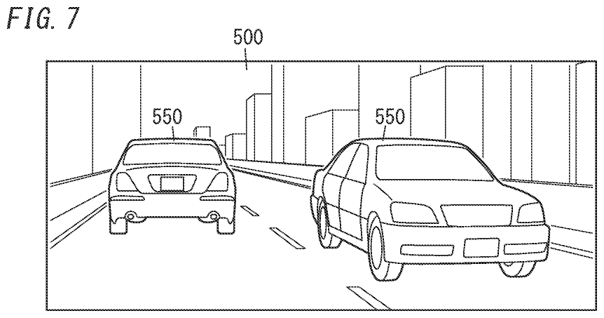

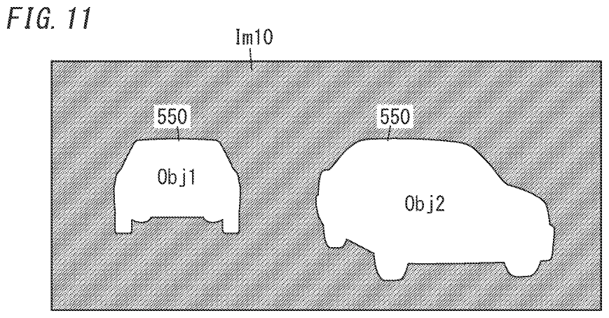

Next described is a method how to the object information generator 131 (e.g., the first generator 1311 to the fifth generator 1315) generates the pieces of the object information A1 to A5 with reference to FIG. 6 to FIG. 11. FIG. 6 is a flowchart illustrating a flow of a processing performed by the object information generator 131. The following explanation is made for the operation about the distance section R1, but the same can be applied for the operations about other distance sections R2 to R5. The following explanation is made while referring to a measurement result of an exemplified target space 500 shown in FIG. 7 if necessary. In the exemplified target space 500 shown in FIG. 7, two objects 550 (specifically, vehicles) are present in the distance section R1.

The object information generator 131 (e.g., the first generator 1311) receives, through the signal receiving unit 12, the distance section signal Si1 associated with the distance section R1 out of the plurality of distance sections R1 to R5 (S1).

When receiving the distance section signal Si1, the object information generator 131 performs a preprocessing on the distance section signal Si1 (S2). Examples of the preprocessing include setting processing of the world coordinate, removing processing of the background signal, and removing processing of the dark current peculiar to the APD if the photoelectric conversion element D10 of the pixel 311 includes the APD.

The setting processing of the world coordinate may include the coordinate conversion processing of converting from a device coordinate defined based on the sensor system 200 (optical sensor 3) into the world coordinate which is the orthogonal coordinate system defined within a virtual space corresponding to the target space 500. According to the world coordinate of the orthogonal coordinate system, the size of the region occupied by an object 550 within the virtual space is constant even if the position of the object 550 changes. Therefore, in a case where the size of the object 550 is used as one of the features, the conversion into the world coordinate can eliminate the need for the change in a reference which is to be compared with this feature even when the position of the object changes. Accordingly, this can make it easy to evaluate the feature.

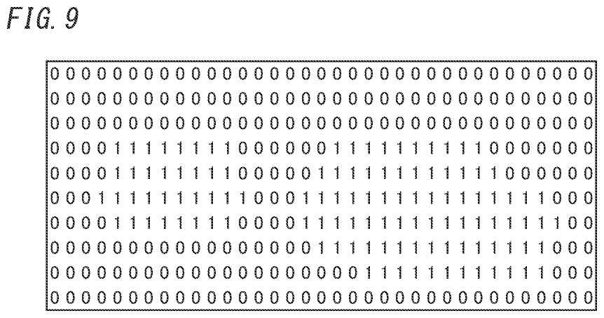

The preprocessing provides data that indicates the distance section image Im10 (binary image) as shown in FIG. 8, for example. FIG. 8 illustrates a binary image where the white color (value of “1”) is given to the pixels 311 corresponding to a region where any of the objects 550 is present, and the black color (value of “0”) is given to pixels 311 corresponding to a region where no object 550 is present. FIG. 9 illustrates an image of the data (binary data) corresponding to FIG. 8, where the value “1” is given to the pixels 311 corresponding to a region where any of the objects 550 is present and the value “0” is given to the pixels 311 corresponding to a region where no object 550 is present. For the sake of the simplification, in FIG. 9, not all the pixels 311 of the values are shown, i.e., some of the pixels 311 are shown but the rest of the pixels 311 are omitted.

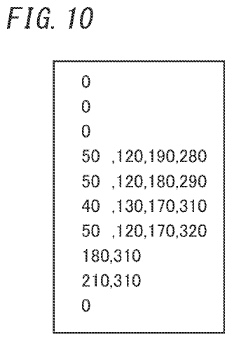

After the preprocessing (S2), the object information generator 131 performs the run-length coding (RLC) processing on the distance section image Im10 indicated by the distance section signal Si1 (S3) to generate run-length data (RL data). This provides the RL data shown in FIG. 10, for example. Rows of the RL data shown in FIG. 10 correspond to rows of the binary data shown in FIG. 9, respectively. Each row of the RL data shown in FIG. 10 includes only the first column number and the last column number of a region in which the value “1” appears continuously. It should be noted that the RL data is decodable to the original binary data. Performing the RLC processing can significantly reduce the data size compared to the pre-RLC processing data.

After the RLC processing (53), the object information generator 131 analyses the RL data in terms of the connectivity to determine whether any object 550 is present or not (S4). Specifically, the object information generator 131 analyses the RL data to determine whether the regions of the respective rows in each of which the value “1” appears continuously are continuous or not in the vertically adjacent rows. Furthermore, the object information generator 131 specifies, as one “block”, a collection of the pixels to each of which the value “1” is given and which are adjacent to each other. When finding that the number of the pixels 311 that constitute the one “block” is greater than or equal to a threshold, the object information generator 131 determines that an object 550 is present at a region of the pixels 311 corresponding to the “block”. The object information generator 131 gives different labels (label data) to the determined objects 550 on the object 550 basis. Specifically, in the example shown in FIG. 8, the region of the left object 550 is given a label of “Obj1”, and the region of the right object 550 is given a label of “Obj2”. When finding that there is no pixel 311 to which the value “1” is given, or the number of the pixels 311 that constitute the one “block” is less than the threshold, the object information generator 131 determines that no object 550 is present in the target distance section.

In short, the object information generator 131 is configured to generate, based on the distance section signal Si1 associated with the target distance section R1, the distance section image Im10 represented by pixel values of the plurality of pixels 311. The pixel values indicate whether the plurality of pixels 311 have received the light L2 or not, respectively. The object information generator 131 is further configured to extract, from the plurality of pixels 311 constituting the distance section image Im10, the region of pixels 311 that have received the light L2 and that are continuously adjacent to each other, and then determine the region to correspond to one object 550. The object information generator 131 is further configured to, when finding that there are a plurality of the regions each of which is determined to correspond to the one object 550 within the distance section image Im10, give different labels (Obj1, Obj2) to the plurality of the objects 550.

After the determination whether the object 550 is present or not (S4), the object information generator 131 extracts the feature with respect to each object 550 (S5). In the embodiment, the object information generator 131 extracts a plurality of features with respect to each object 550. The object information generator 131 extracts the features of one object 550 based on the region of the continuous pixels 311 determined to correspond to this object 550. Examples of the features include the area, the length (boundary length), the first moment in the column direction, the first moment in the row direction, the second moment, the center of gravity, the length of the principal axis of inertia 1, the length of the principal axis of inertia 2, the direction of the principal axis of inertia 1, the direction of the principal axis of inertia 2, the symmetry property (e.g., (the length of the principal axis of inertia 1)/(the length of the principal axis of inertia 2)), the given label, the section information indicative of the distance section, and the like, of the object 550 (i.e., the continuous pixels 311 determined to correspond to the object 550). When finding that there are a plurality of the regions each of which is determined to correspond to an object 550, the object information generator 131 extracts the features with respect to each object 550 (each of the regions corresponding to the respective objects 550). In short, the object information generator 131 is configured to generate the piece of the object information including the feature(s) of the object 550 that includes at least one selected from the group consisting of the area, the length, the first moment in the column direction, the first moment in the row direction, the second moment, the center of gravity, the principal axis, and the symmetry property.

After the extraction of the features (S5), the object information generator 131 generates, with respect to each object 550 (each region of the continuous pixels 311 corresponding to the object 550), a piece of vector data having components that are the values of the plurality of features of the object (S6). The piece of the vector data has a dimension corresponding to the number of types of the extracted features.

In short, the object information generator 131 is configured to, based on the region of the pixels 311 continuously adjacent to each other and determined to correspond to the one object 550, extract a plurality of the features of this object 550. The object information generator 131 is further configured to generate, as the piece of the object information, the piece of the vector data of which components are the plurality of features of this object 550.

Furthermore, the object information generator 131 performs a recognition processing to recognize the object 550. The object information generator 131 may recognize that the object 550 is a vehicle or a person, and so on, and generate recognition data indicative of the recognition result, for example. The object information generator 131 may recognize the object based on a known pattern recognition method, for example.

The object information generator 131 outputs the generated data as the object information (as the piece of the object information A1 in this case) (S7). The data output as the object information (as the piece of the object information A1) from the object information generator 131 may include at least one selected from the group consisting of the RL data, the label data, the vector data, and the recognition data of the object 550. The piece of the object information A1 may be data (such as the RL data) decodable to the distance section signal Si1. The piece of the object information has a data size smaller than a data size of information indicated by the distance section signal Si1.

When there are two or more objects 550, the piece of the object information A1 output from the object information generator 131 may include two or more pieces of the object information corresponding respectively to the two or more objects 550. According to the example of FIG. 5, the object information generator 131 may generate, as the piece of the object information A1, pieces of the object information A11, A12, . . . , in relation to the distance section R1. Likewise, the object information generator 131 may generate, as the piece of the object information A2, pieces of the object information A21, A22, . . . , in relation to the distance section R2. The object information generator 131 may generate, as the piece of the object information A3, pieces of the object information A31, A32, . . . , in relation to the distance section R3. The object information generator 131 may generate, as the piece of the object information A4, pieces of the object information A41, A42, . . . , in relation to the distance section R4. The object information generator 131 may generate, as the piece of the object information A5, pieces of the object information A51, A52, . . . , in relation to the distance section R5. Each of the pieces of the object information A11, A12, A21, A22, A31, A32, A41, A42, A51, A52, . . . may include a piece of vector data.

The inter-section information generator 132 is configured to, when finding there is an object 550 present in each of different two distance sections out of the plurality of distance sections R1 to R5, determine whether the two objects 550 present in the two distance sections belong to a same object or not based on a distance between pieces of vector data of the two objects 550. As an example, when one object 550 lies across the boundary of two distance sections R1, R2, the inter-section information generator 132 can determine that an object 550 present in the distance section R1 and an object 550 present in the distance section R2 belong to the same object 550, based on the distance between the pieces of vector data of them.

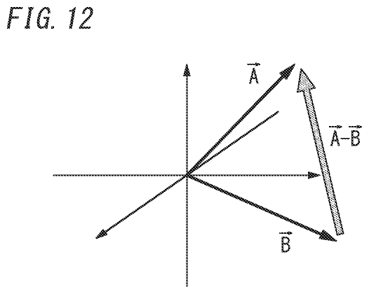

Specifically, the inter-section information generator 132 receives from the first generator 1311 a piece of the object information A11 including a piece of vector data \vec{A} about an object 550, and receives from the second generator 1312 a piece of the object information A21 including a piece of vector data \vec{B} about an object 550, for example. When receiving the piece of the object information A11 and the piece of the object information A2, the inter-section information generator 132 calculates a distance |\vec{A}-\vec{B}| between the piece of vector data \vec{A} and the piece of vector data \vec{B}, as shown in FIG. 12. When finding that the calculated distance is smaller than a threshold, the inter-section information generator 132 determines that these two objects 550 belong to the same object as each other, and outputs the determination result to the output unit 14. On the other hand, when finding that the calculated distance is equal to or greater than the threshold, the inter-section information generator 132 determines that these two objects 550 are different objects from each other, and outputs the determination result to the output unit 14. The inter-section information generator 132 performs such a determination processing with regard to every combination of different pieces of vector data included in different pieces of the object information, and outputs the determination results to the output unit 14. For example, with regard to the combination of the piece of the object information A1 and the piece of the object information A2, the inter-section information generator 132 performs the determination processing on: a combination of the piece of the object information A11 and the piece of the object information A21, a combination of the piece of the object information A11 and the piece of the object information A22, a combination of the piece of the object information A12 and the piece of the object information A21, and a combination of the piece of the object information A12 and the piece of the object information A22, for example. It should be noted that respective pieces of vector data are shown in the three dimensions in FIG. 12, but the dimension of the respective pieces of vector data may correspond to the number of the features, as described above.

The distance image generator 133 is configured to generate the distance image Im100 of the distance measurable range FR including the plurality of distance sections R1 to R5. The distance image generator 133 is configured to generate the distance image Im100 based on the plurality of distance section signals Si1 to Si5 associated respectively with the plurality of distance sections R1 to R5. The distance image generator 133 gives colors (or weights) to the regions of the pixels 311 corresponding to the objects 550, such that different colors (or weights) are given to the different distance section images Im1 to Im5 indicated by the plurality of distance section signals Si1 to Si5. The distance image generator 133 then add to each other the plurality of distance section images Im1 to Im5 to which the colors (weights) are given, thereby generating the distance image Im100. The distance image generator 133 outputs, to the output unit 14, data indicative of the generated distance image Im100.

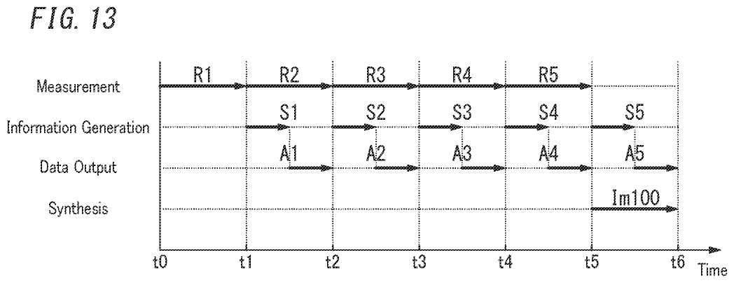

In the embodiment, the distance image generator 133 is configured to generate the distance image Im100, after the object information generator 131 generates a piece of the object information about at least one distance section R1. Specifically, the distance image generator 133 starts the generation processing of the distance image Im100, after the object information generator 131 finishes the generation processing of the piece of the object information about the at least one distance section R1. FIG. 13 illustrates schematic relationship in the time axis among: the light receiving operations performed by the optical sensor 3; the generation operations of the pieces of the object information performed by the object information generator 131; the output operations of the pieces of the object information performed by the output unit 14; and the generation (synthesizing) operation of the distance image Im100 performed by the distance image generator 133. In FIG. 13, the line “Measurement” indicates a distance section of which distance measurement is preformed with the optical sensor 3, among the plurality of distance sections R1 to R5. The line “Information Generation” indicates a distance section signal from which the object information generator 131 generates a piece of the object information by performing the signal processing thereon, among the distance section signals Si1 to Si5. The line “Data Output” indicates a piece of the object information output from the output unit 14, among the pieces of the object information A1 to A5. The line “Synthesis” indicates a timing when the distance image generator 133 generates the distance image Im100. Note that the origin of an arrow in each line of FIG. 13 indicates a start time of a processing (measurement, generation, output, or synthesis), and the end of the arrow indicates an end time of the processing.

As shown in FIG. 13, the optical sensor 3 performs the measurement in relation to the distance section R1 during a period (hereinafter, referred to as “period T1”) between a time point t0 to a time point t1 to generate the distance section signal Si1. Also, the optical sensor 3 performs the measurement in relation to the distance section R2 during a period (hereinafter, referred to as “period T2”) between the time point t1 to a time point t2 to generate the distance section signal Si2. The optical sensor 3 performs the measurement in relation to the distance section R3 during a period (hereinafter, referred to as “period T3”) between the time point t2 to a time point t3 to generate the distance section signal Si3. The optical sensor 3 performs the measurement in relation to the distance section R4 during a period (hereinafter, referred to as “period T4”) between the time point t3 to a time point t4 to generate the distance section signal Si4. The optical sensor 3 performs the measurement in relation to the distance section R5 during a period (hereinafter, referred to as “period T5”) between the time point t4 to a time point t5 to generate the distance section signal Si5.

The object information generator 131 performs the determination processing about the object with regard to each distance section in the sequential order, using the distance section signal associated with the distance section of which the measurement by the optical sensor 3 has finished. Specifically, the object information generator 131 processes the distance section signal Si1 during the period T2, processes the distance section signal Si2 during the period T3, processes the distance section signal Si3 during the period T4, processes the distance section signal Si4 during the period T5, and processes the distance section signal Si5 during a period between the time point t5 and a time point T6. That is, the object information generator 131 performs the processing on the distance section signal Si1 associated with the distance section R1 of which the measurement by the optical sensor 3 has finished at the period T1, without waiting the optical sensor 3 finishes the measurements about the whole distance sections (at the time point t5), for example. This enables to perform the processing in semi-real time, compared to a case where the processing on the distance section signal is performed after the finish of the measurement about the whole distance sections.

The output unit 14 also sequentially outputs the pieces of the object information A1 to A4 generated by the object information generator 131 without waiting the optical sensor 3 finishes the measurements about the whole distance sections (at the time point t5), as shown in FIG. 13.

The pieces of the object information A1 to A5 are generated and output according to this time-line, and therefore the distance image generator 133 generates the distance image Im100, after the object information generator 131 generates the piece of the object information A1 about the at least one distance section R1. It is because the generation processing of the distance image Im100 requires the respective distance section signals Si1 to Si5 associated with all the distance sections R1 to R5.

The output unit 14 is configured to output, to at least one of the presenting unit 15 or the external device 6, the pieces of the object information generated by the object information generator 131, determination results of the inter-section information generator 132, and the distance image Im100 generated by the distance image generator 133. As described above, the output unit 14 is configured to, before the distance image is generated, output a piece of the object information (the piece of the object information A1) about at least one distance section (distance section R1). The output unit 14 may further be configured to output the distance section images Im1 to Im5. The output unit 14 may be configured to output the information in a form of a wireless signal.

The presenting unit 15 is configured to visually present the information output from the output unit 14. The presenting unit 15 may include a two-dimensional display such as a liquid crystal display or an organic EL display, for example. The presenting unit 15 may include a three-dimensional display to display the distance image three dimensionally. That is, the presenting unit 15 is configured to visually present the distance image Im100.

In summary, it is understood from the above description, the information processing system 100 of the present embodiment is configured to generate the piece of the object information about the object 550 present in each of the plurality of distance sections R1 to R5, based on the distance section signal associated with the target distance section. This can contribute to reduce the processing time.

When the sensor system 200 is used for the obstacle detection purpose, all the information necessary for the external device 6 may be a distance section in which any object 550 is present. In such a case, there is no need to determine the accurate distance of the object 550 by using the distance image of the whole distance measurable range FR. The information processing system 100 of the present embodiment may be preferably used in such a case.

Furthermore, the information processing system 100 of the present embodiment can significantly reduce the data size of the information output to the external device 6, compared to a case where the distance image is output to the external device 6 and the object information is generated by the external device 6.

Explanation is given more in detail according to a specific case where the light receiving unit 31 includes total 100,000 pixels 311 which are arranged in a matrix pattern of 100 rows×100 columns. In this case, the distance image, generated by giving different colors to the objects 550 of different distance sections may have a data size of 3 M bytes (the number of pixels: 100000×3 bytes (RGB)), for example. This 3 M bytes data of the distance image is output to the external device 6.

On the other hand, in the information processing system 100 of the present embodiment, the distance section image Im10 processed by the object information generator 131 is a binary image and may have a data size of 1 M bytes. After the object information generator 131 processes the distance section image Im10 to obtain the RL data, the data size may be reduced to 8 K bytes (=2 (the number of objects)×4 bytes (data size of one object=dimensions (2)×coordinate values)×1000 (the number of rows), in case where there are two regions each corresponding to the object 550 within the distance section image Im10), for example. When the data is further compressed to the vector data, which includes 10 features as its components, the data size is reduced to 80 bytes (=4 bytes (data amount of one feature)×10 (the number of features)×2 (the number of objects)). This can reduce the data size of the data to be output to as small as 400 bytes, in a case where the number of distance sections is 5. Consequently, the information processing system 100 of the present embodiment can improve the processing speed by the reduction of the data size to be output.

### (3) Variation

The embodiment described above is only one of various embodiments of the present disclosure, and may be readily modified, changed, replaced, or combined with any other embodiments, depending on a design choice or any other factor, without departing from the scope of the present disclosure. Also, the same function as that of the information processing system 100 according to the embodiment described above may be implemented as a computer program, or a non-transitory storage medium that stores the computer program thereon, for example.

An information processing method according to an aspect is an information processing method for performing processing on information indicated by an electric signal Si10 generated by an optical sensor 3. The optical sensor 3 includes a light receiving unit 31 configured to receive a reflection light L2 that is a measuring light L1 emitted from a light emitting unit 2 toward a target space 500, reflected from a distance measurable range FR within the target space 500. The optical sensor 3 generates the electric signal Si10 according to a pixel 311 that has received the reflection light L2 out of a plurality of pixels 311 of the light receiving unit 31. The information processing method includes generating object information A1 to A5. A piece of the object information A1 is information indicating a feature of an object 550 present in a target distance section R1. The target distance section R1 is one selected from a plurality of distance sections R1 to R5 defined by dividing the distance measurable range FR in accordance with differences in elapsed time from a point of time when the light emitting unit 2 emits the measuring light L1. The electric signal Si10 includes a plurality of distance section signals Si1 to Si5 associated respectively with the plurality of distance sections R1 to R5. The information processing method includes generating the piece of the object information A1 based on a distance section signal Si1 associated with the target distance section R1, out of the plurality of distance section signals Si1 to Si5. The information processing method includes outputting the pieces of the object information A1 to A5.

A program according, to an aspect is a program configured to cause one or more processors to execute the information processing method. The program may be stored on computer readable medium.

Variations of the embodiment will be described hereinbelow. The variations described hereinafter may be appropriately combined with the embodiment described above.

The measurement controller 11 and the signal processor 13 in the information processing system 100 according to the present disclosure includes a computer system. The computer system may include, as principal hardware components, a processor and a memory. The functions of the processor 35 according to the present disclosure may be performed by making the processor execute a program stored in the memory of the computer system. The program may be stored in advance in the memory of the computer system. Alternatively, the program may also be downloaded through a telecommunications line or be distributed after having been recorded in some non-transitory storage medium such as a memory card, an optical disc, or a hard disk drive, any of which is readable for the computer system. The processor of the computer system may be made up of a single or a plurality of electronic circuits including a semiconductor integrated circuit (IC) or a large-scale integrated circuit (LSI). As used herein, the “integrated circuit” such as an IC or an LSI is called by a different name depending on the degree of integration thereof. Examples of the integrated circuits include a system LSI, a very large-scale integrated circuit (VLSI), and an ultra large-scale integrated circuit (ULSI). Optionally, a field-programmable gate array (FPGA) to be programmed after an LSI has been fabricated or a reconfigurable logic device allowing the connections or circuit sections inside of an LSI to be reconfigured may also be adopted as the processor. Those electronic circuits may be either integrated together on a single chip or distributed on multiple chips, whichever is appropriate. Those multiple chips may be integrated together in a single device or distributed in multiple devices without limitation. As used herein, the “computer system” includes a microcontroller including one or more processors and one or more memories. Thus, the microcontroller may also be implemented as a single or a plurality of electronic circuits including a semiconductor integrated circuit or a largescale integrated circuit.

Also, in the embodiment described above, the plurality of constituent elements (or the functions) of the information processing system 100 are integrated together in a single housing. However, this is only an example and should not be construed as limiting. Alternatively, those constituent elements (or functions) of the information processing system 100 may be distributed in multiple different housings. Still alternatively, at least some functions of the information processing system 100 may be implemented as a cloud computing system as well. Conversely, the plurality of functions of the information processing system 100 may be integrated together in a single housing.

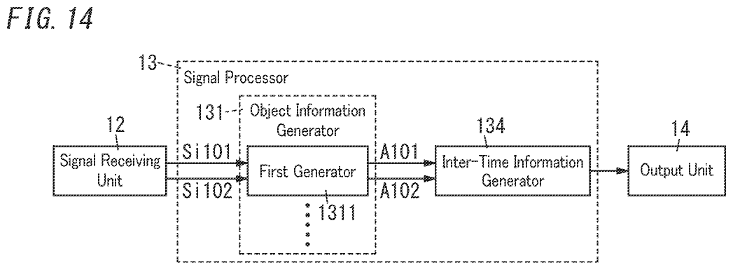

In one variation, an information processing system 100 may include an inter-time information generator 134, as shown in FIG. 14. An object information generator 131 may be configured to generate, based on two distance section signals Si101, Si102 generated at different timings but associated with a same distance section R1, two distance section images, respectively. The object information generator 131 may further be configured to generate two pieces of the object information A101, A102 each of which is about the object 550 determined to be included in a corresponding one of the two distance section images. Each of the two pieces of the object information A101, A102 includes a piece of vector data of the object 550 determined to be included in a corresponding one of the two distance section images. The inter-time information generator 134 may be configured to, when finding there is the object 550 determined to be included in each of the two distance section images, determine whether the objects 550 determined to be included in the two distance section images belong to a same object or not based on a distance between the pieces of vector data of the objects 550 determined to be included in the two distance section images.

According to the example of FIG. 14, the distance section signals Si101, Si102 are generated in association with the identical distance section R1, but at different timings. In this example, the distance section signal Si101 is generated first according to the distance measurement on the distance section R1, and then the distance section signals Si2 to Si5 associated with the other distance sections R2 to R5 are sequentially generated, thereafter the distance section signal Si102 is generated according to the next distance measurement on the distance section R1.

In one variation, a sensor system 200 may generate a distance section signal(s) not according to the direct TOF method as in the embodiment, but to the indirect TOF method.

In one variation, an information processing system may generate pieces of object information (A1 to A5) based further on a distance image Im100.

### (4) Aspect

As is understood from the embodiment and variations described above, the present disclosure discloses the following aspects.

An information processing system (100) of a first aspect is an information processing system for performing processing on information indicated by an electric signal (Si10) generated by an optical sensor (3). The optical sensor (3) includes a light receiving unit (31) configured to receive a reflection light (L2) that is a measuring light (L1) emitted from a light emitting unit (2) toward a target space (500), reflected from a distance measurable range (FR) within the target space (500). The light receiving unit (31) includes a plurality of pixels (311). The electric signal (Si10) indicates information about a pixel (311) that has received the reflection light (L2) out of the plurality of pixels (311). The information processing system (100) includes an object information generator (131) and an output unit (14). The object information generator (131) is configured to generate object information (A1 to A5). A piece of the object information (A1) indicates a feature of an object (550) present in a target distance section (R1). The target distance section (R1) is one selected from a plurality of distance sections (R1 to R5) defined by dividing the distance measurable range (FR) in accordance with differences in elapsed times from a point of time when the light emitting unit (2) emits the measuring light (L1). The electric signal (Si10) includes a plurality of distance section signals (Si1 to Si5) associated respectively with the plurality of distance sections (R1 to R5). The object information generator (131) is configured to generate the piece of the object information (A1) based on a distance section signal (Si1) associated with the target distance section (R1), out of the plurality of distance section signals (Si1 to Si5).

This aspect can contribute to reduce the processing time.

The information processing system (100) of a second aspect with reference to the first aspect further includes a distance image generator (133). The distance image generator (133) is configured to generate a distance image (Im100) of the distance measurable range (FR) based on the plurality of distance section signals (Si1 to Si5) associated respectively with the plurality of distance sections (R1 to R5). The distance image generator (133) is configured to generate the distance image (Im100), after the object information generator (131) generates the piece of the object information (A1) about at least one distance section (R1) of the plurality of distance sections.

This aspect can contribute to reduce the processing time.

The information processing system (100) of a third aspect with reference to the second aspect further includes a presenting unit (15) configured to visually present the distance image (Im100).

This aspect allows a user to see the distance image (Im100), thereby allowing the user to easily understand the state of the target space (500).

In the information processing system (100) of a fourth aspect, with reference to the second or third aspect, the output unit (14) is configured to, before the distance image generator (133) generates the distance image (Im100), output the piece of the object information (A1) about the at least one distance section (R1).

This aspect allows an external device (6) to receive the piece of the object information (A1) about the distance section (R1) and perform a processing on the piece of the object information (A1) without waiting the generation of the distance image (Im100).

In the information processing system (100) of a fifth aspect, with reference to any one of the first to fourth aspects, the plurality of pixels (311) are arranged in a two-dimensional array. The object information generator (131) is configured to generate, based on the distance section signal (Si1) associated with the target distance section (R1), a distance section image (Im10) represented by pixel values of the plurality of pixels (311). The pixel values indicate whether the plurality of pixels have received the reflection light (L2) or not, respectively. The object information generator (131) is configured to extract, from the plurality of pixels (311) constituting the distance section image (Im10), a region of pixels (311) that have received the reflection light (L2) and that are continuously adjacent to each other, and then determine the region to correspond to one object (550) as the object. The object information generator (131) is configured to, when finding that there are a plurality of the regions each of which is determined to correspond to the one object (550) within the distance section image (Im10), give different labels (Obj1, Obj2) to a plurality of the objects (550).

This aspect can contribute to reduce the processing load on a device (such as the external device 6) that performs processing on the piece of the object information (A1).

In the information processing system (100) of a sixth aspect, with reference to any one of the first to fifth aspects, the optical sensor (3) is configured to determine whether each of the plurality of pixels (311) receives the reflection light (L2) or not, based on results of a plurality times of light receiving operation. Each of the plurality times of light receiving operation includes an emission of the measuring light (L1) from the light emitting unit (2) and an exposure operation of the pixel (311).

This aspect can contribute to reduce the influence of the noise.

In the information processing system (100) of a seventh aspect, with reference to any one of the first to sixth aspects, the plurality of pixels (311) are arranged in a two-dimensional array. The object information generator (131) is configured to generate, based on the distance section signal (Si1) associated with the target distance section (R1), a distance section image (Im1) represented by pixel values of the plurality of pixels (311). The pixel values indicates whether the plurality of pixels have received the reflection light (L2) or not, respectively. The object information generator (131) is configured to extract, from the plurality of pixels (311) constituting the distance section image (Im1), a region of pixels (311) that have received the reflection light (L2) and that are continuously adjacent to each other, and then determine the region to correspond one object (550) as the object. The object information generator (131) is configured to, based on the region of the pixels (311) continuously adjacent to each other and determined to correspond to the one object (550), extract a plurality of the features of the one object (550). The piece of the object information (A1) includes a piece of vector data of which components are the plurality of features of the one object (550).

This aspect can contribute to reduce the processing time.

The information processing system (100) of an eighth aspect with reference to the seventh aspect further includes an inter-section information generator (132). The inter-section information generator (132) is configured to, when finding there is the object (550) present in each of different two distance sections (R1, R2) out of the plurality of distance sections (R1 to R5), determine whether the objects present in the two distance sections belong to a same object or not based on a distance between the pieces of vector data of the objects (550) present in the two distance sections.

This aspect can make it easy to determine whether objects (550) present in different distance sections belong to a same object or not.

In the information processing system (100) of a ninth aspect, with reference to the seventh or eighth aspect, the object information generator (131) is configured to generate, based on two distance section signals (Si101, Si102) generated at different timings but associated with a same distance section (R1), two distance section images, respectively. The object information generator (131) is configured to generate two pieces of the object information (A101, A102) each of which is about the object (550) determined to be included in a corresponding one of the two distance section images. Each of the two pieces of the object information (A101, A102) includes a piece of vector data of the object (550) determined to be included in a corresponding one of the two distance section images. The information processing system (100) is configured to, when finding there is the object (550) determined to be included in each of the two distance section images, determine whether the objects (550) determined to be included in the two distance section images belong to a same object or not based on a distance between the pieces of vector data of the objects (550) determined to be included in the two distance section images.

This aspect can make it easy to determine whether objects (550) present in different distance section images generated in association with the same distance section (R1) belong to a same object or not.

In the information processing system (100) of a tenth aspect, with reference to any one of the first to ninth aspects, the piece of the object information (A1) has a form decodable to the distance section signal (Si1). The piece of the object information (A1) has a data size smaller than a data size of information indicated by the distance section signal (Si1).

This aspect can contribute to reduce the processing time.

A sensor system (200) of an eleventh aspect includes the information processing system (100) of any one of the first to tenth aspects and the optical sensor (3).

This aspect can contribute to reduce the processing time.

An information processing method of a twelfth aspect is an information processing method for performing processing on information indicated by an electric signal (Si10) generated by an optical sensor (3). The optical sensor (3) includes a light receiving unit (31) configured to receive a reflection light (L2) that is a measuring light (L1) emitted from a light emitting unit (2) toward a target space (500), reflected from a distance measurable range (FR) within the target space (500). The light receiving unit (31) includes a plurality of pixels (311). The electric signal (Si10) indicates information about a pixel (311) that has received the reflection light (L2) out of the plurality of pixels (311). The information processing method includes generating object information (A1 to A5). A piece of the object information (A1) indicates a feature of an object (550) present in a target distance section (R1). The target distance section (R1) is one selected from a plurality of distance sections (R1 to R5) defined by dividing the distance measurable range (FR) in accordance with differences in elapsed times from a point of time when the light emitting unit (2) emits the measuring light (L1). The electric signal (Si10) includes a plurality of distance section signals (Si1 to Si5) associated respectively with the plurality of distance sections (R1 to R5). The step of generating the object information includes generating the piece of the object information (A1) based on a distance section signal (Si1) associated with the target distance section (R1), out of the plurality of distance section signals (Si1 to Si5). The information processing method includes outputting the object information (A1 to A5).

This aspect can contribute to reduce the processing time.

A program of a thirteenth aspect is a program configured to cause one or more processors to execute the information processing method of the twelfth aspect.

This aspect can contribute to reduce the processing time.

### REFERENCE SIGNS LIST

2 Light Emitting Unit

3 Optical Sensor

31 Light Receiving Unit

311 Pixel

100 Information Processing System

131 Object Information Generator

132 Inter-section Information Generator

133 Distance Image Generator

134 Inter-time Information Generator

14 Output Unit

15 Presenting unit

200 Sensor System

500 Target Space

550 Object

A1 to A5 Object information

FR Distance Measurable Range

Im10 Distance Section Image

Im100 Distance Image

L1 Measuring Light

L2 Light (Reflection Light)

Obj1, Obj2 Label

R1 to R5 Distance Section

Si1 to Si5 Distance Section Signal

1. An information processing system for performing processing on information indicated by an electric signal generated by an optical sensor, the optical sensor including a light receiving unit configured to receive a reflection light that is a measuring light emitted from a light emitting unit toward a target space, reflected from a distance measurable range within the target space, the electric signal indicating information about a pixel that has received the reflection light out of a plurality of pixels of the light receiving unit, the information processing system comprising:
an object information generator configured to generate object information; and
an output unit configured to output the object information,
a piece of the object information indicating a feature of an object which is present in a target distance section, the target distance section being one selected from a plurality of distance sections defined by dividing the distance measurable range in accordance with difference in elapsed times from a point of time when the light emitting unit emits the measuring light,
the electric signal including a plurality of distance section signals associated respectively with the plurality of distance sections,
the object information generator being configured to generate the piece of the object information based on a distance section signal associated with the target distance section, out of the plurality of distance section signals.

2. The information processing system of claim 1, further comprising a distance image generator configured to generate a distance image of the distance measurable range based on the plurality of distance section signals associated respectively with the plurality of distance sections, wherein
the distance image generator is configured to generate the distance image, after the object information generator generates the piece of the object information about at least one distance section of the plurality of distance sections.

3. The information processing system of claim 2, further comprising a presenting unit configured to visually present the distance image.

4. The information processing system of claim 2, wherein the output unit is configured to, before the distance image generator generates the distance image, output the piece of the object information about the at least one distance section.

5. The information processing system of claim 1, wherein
the plurality of pixels are arranged in a two-dimensional array,
the object information generator is configured to
generate, based on the distance section signal associated with the target distance section, a distance section image represented by pixel values of the plurality of pixels, the pixel values indicating whether the plurality of pixels have received the reflection light or not, respectively,
extract, from the plurality of pixels constituting the distance section image, a region of pixels that have received the reflection light and that are continuously adjacent to each other, and then determine the region to correspond to one object as the object, and
when finding that there are a plurality of the regions each of which is determined to correspond to the one object within the distance section image, give different labels to a plurality of the objects.

6. The information processing system of claim 1, wherein
the optical sensor is configured to determine whether each of the plurality of pixels receives the reflection light or not based on results of a plurality times of light receiving operation, and
each of the plurality times of light receiving operation includes an emission of the measuring light from the light emitting unit and an exposure operation of the pixel.

7. The information processing system of claim 1, wherein
the plurality of pixels are arranged in a two-dimensional array,
the object information generator is configured to
generate, based on the distance section signal associated with the target distance section, a distance section image represented by pixel values of the plurality of pixels, the pixel values indicating whether the plurality of pixels have received the reflection light or not, respectively,
extract, from the plurality of pixels constituting the distance section image, a region of pixels that have received the reflection light and that are continuously adjacent to each other, and then determine the region to correspond to one object as the object, and
based on the region of the pixels continuously adjacent to each other and determined to correspond to the one object, extract a plurality of the features of the one object,
the piece of the object information includes a piece of vector data of which components are the plurality of features of the one object.

8. The information processing system of claim 7, further comprising an inter-section information generator configured to, when finding there is the object present in each of different two distance sections out of the plurality of distance sections, determine whether the objects present in the two distance sections belong to a same object or not based on a distance between the pieces of vector data of the objects present in the two distance sections.

9. The information processing system of claim 7, wherein
the object information generator is configured to
generate, based on two distance section signals generated at different timings but associated with a same distance section, two distance section images, respectively, and
generate two pieces of the object information each of which is about the object determined to be included in a corresponding one of the two distance section images,
each of the two pieces of the object information includes a piece of vector data of the object determined to be included in a corresponding one of the two distance section images,
the information processing system further comprises an inter-time information generator configured to, when finding there is the object determined to be included in each of the two distance section images, determine whether the objects determined to be included in the two distance section images belong to a same object or not based on a distance between the pieces of vector data of the objects determined to be included in the two distance section images.

10. The information processing system of claim 1, wherein
the piece of the object information has a form decodable to the distance section signal,
the piece of the object information has a data size smaller than a data size of information indicated by the distance section signal.

11. A sensor system, comprising:
the information processing system for performing processing on information indicated by an electric signal generated by an optical sensor; and
the optical sensor including a light receiving unit configured to receive a reflection light that is a measuring light emitted from a light emitting unit toward a target space, reflected from a distance measurable range within the target space,
the electric signal indicating information about a pixel that has received the reflection light out of a plurality of pixels of the light receiving unit,
the information processing system comprising:
an object information generator configured to generate object information; and
an output unit configured to output the object information,
a piece of the object information indicating a feature of an object which is present in a target distance section, the target distance section being one selected from a plurality of distance sections defined by dividing the distance measurable range in accordance with difference in elapsed times from a point of time when the light emitting unit emits the measuring light,
the electric signal including a plurality of distance section signals associated respectively with the plurality of distance sections,
the object information generator being configured to generate the piece of the object information based on a distance section signal associated with the target distance section, out of the plurality of distance section signals.

12. An information processing method for performing processing on information indicated by an electric signal generated by an optical sensor, the optical sensor including a light receiving unit configured to receive a reflection light that is a measuring light emitted from a light emitting unit toward a target space, reflected from a distance measurable range within the target space, the electric signal indicating information about a pixel that has received the reflection light out of a plurality of pixels of the light receiving unit, the information processing method comprising:
generating object information; and
outputting the object information,
a piece of the object information indicating a feature of an object which is present in a target distance section, the target distance section being one selected from a plurality of distance sections defined by dividing the distance measurable range in accordance with differences in elapsed times from a point of time when the light emitting unit emits the measuring light,
the electric signal including a plurality of distance section signals associated respectively with the plurality of distance sections,
generating the object information including generating the piece of the object information based on a distance section signal associated with the target distance section, out of the plurality of distance section signals.

13. A non-transitory computer readable storage medium that stores a program configured to cause one or more processors to execute the information processing method of claim 12.
